(19) United States
(12) Patent Application Publication
(10) Pub. No.: US 2025/0376382 A1
(43) Pub. Date: Dec. 11, 2025

(54) LITHIUM EXTRACTION FROM A GEOTHERMAL BRINE BY ADVANCED CARBONATION PROCESSING

(71) Applicants: Jinichiro Nakano, Albany, OR (US); Anna Nakano, Albany, OR (US)

(72) Inventors: Jinichiro Nakano, Albany, OR (US); Anna Nakano, Albany, OR (US)

(21) Appl. No.: 18/738,052

(22) Filed: Jun. 9, 2024

Related U.S. Application Data
(63) Continuation-in-part of application No. 18/738,049, filed on Jun. 9, 2024.

(51) Int. Cl. C01D 15/08; C22B 3/22; C22B 26/12

(52) U.S. Cl. CPC C01D 15/08; C22B 3/22; C22B 26/12

(57) ABSTRACT

Low CAPEX/OPEX, effective, and environmentally friendly process of rapidly extracting lithium from geothermal brines and producing lithium carbonate. The method includes adjusting a unique parameter determined based on the modified alkalinity in a quantity of the geothermal brine to a preset value without needing to purposefully modify the pH. Interactions of the anionic reactant species with components within the geothermal brine cause a solid form of the lithium to precipitate out of the geothermal brine. After the solid separation, the spent brine is environmentally safe and returned underground or transported to a reservoir.

### FIELD OF INVENTION

The present invention relates to methods, compositions and devices for simultaneously extracting lithium and generating lithium carbonate from brines using advanced carbonation processing.

### BACKGROUND OF THE INVENTION

Lithium is a member of the alkali metals. Elemental lithium is, in general, not found in nature. Lithium may be present as a cation or in salt form in underground deposits of brine, mineral ore, clay, seawater, and geothermal brines. It can offer excellent heat and electrical conductivity properties. It is useful for the manufacture of lithium-ion batteries as well as other consumer products such as glass, high-temperature lubricants, chemicals, and pharmaceuticals. Most commercial lithium is available in the form of lithium carbonate, which is a comparatively stable compound that can be easily converted to other salts or chemicals as needed.

Lithium can be extracted using chemical, physical, and ionic processes where lithium is isolated from a source and then converted to a saleable form of lithium, generally a stable yet readily convertible compound such as lithium carbonate, hydroxide, and hydrate. Most lithium extraction processes entail some form of mining to reach underground deposits of lithium-rich minerals or brines. Lithium is fairly present on land deposits, however, many sources are considered not economically viable for extraction by conventional technologies.

### BRIEF SUMMARY OF THE INVENTION

This invention is directed to a process for extracting lithium from geothermal brines. The lithium is extracted through advanced carbonation processing by adjusting a unique parameter, the effective alkalinity, determined based on the modified alkalinity in the geothermal brine, to a preset value and recovering the lithium as a precipitate. The precipitate is formed through direct and indirect interactions of the available anionic species with the lithium in the geothermal brine and the surroundings.

The process described herein is a rapid, economical, and environmentally friendly extraction of lithium from geothermal brines. A geothermal brine is, in general, a hot, concentrated, saline solution that has circulated through crustal rocks in an area of anomalously high heat flow and has become enriched in substances leached from the rocks and earth (hereinafter “brine”) and is the input for the system and process described herein. Geothermal fluids by convention may be termed brine even for those with low salinity and low heat.

Currently, the extraction of lithium from brines is conducted in two steps: first, through a lithium concentration step, which is performed by an evaporation pond route or direct lithium extraction (DLE) techniques, then second, through a mineralization step (such as carbonation) typically at separate facilities at different locations. Traditional and emerging DLE approaches such as ion exchange, membranes, adsorption, and nano-filters, which can produce a lithium mineral (e.g., chloride, sulfate, etc.) concentrate or eluate to be carbonated are becoming more promising to replace the currently predominant evaporation pond concentration step. Carbonation by advanced CO₂ gas injection into the liquid medium has been suggested in the past few decades by academia and industries for extraction of a variety of metals including lithium from liquid media. For this approach to be more practically effective, the process has been enhanced by thermodynamic manipulations, for example, pH modification, solid additives, or operation under supercritical conditions. The use of CO₂ microbubbles having a diameter of 50 microns or less was suggested in conjunction with solid additives to promote the carbonation of a liquid to extract metals. The advanced injection of nanobubbles (<1 micron) of gases such as carbon dioxide, ozone, oxygen, air, and nitrogen has been suggested and widely practiced in the past few decades in various industries such as materials, agriculture, fishery, medical, pharmaceutical, environmental, biological, cleaning, and sanitation because the nanobubbles can influence the pH, the solubility limits (i.e., concentrations) of dissolved gas, the population of suspended gas (e.g., non-dissolved), the surface energy of trapped gas, the surface tension of liquid, wettability, and the charges (e.g., zeta potential) in the vicinity of the trapped gas, while providing the ability to be suspended in a liquid medium for an extended period of time (months to years). Because of such wide applications and uses, various advanced techniques of generating nanobubbles and their injection are commercially available worldwide.

In an embodiment of the invention, a rapid, economical, and environmentally friendly extraction of lithium, can be accomplished through carbonation of the brine with one or more of a plurality of different anionic species as facilitated by adjustment of the effective alkalinity. Adjustment of the effective alkalinity in the liquid, using the process described herein, causes carbonation to generate lithium carbonate (Li₂CO₃) from the brine. In particular, the process generates the final product directly from the brine without requiring a pre-concentration step (e.g., evaporation pond, DLE). The invention strongly complements the existing concentration steps if applied to concentrates and eluates produced from the evaporation pond and DLE processes. In an embodiment of the present invention, by adjusting the effective alkalinity under the conditions described in this disclosure, the onset of lithium precipitation occurs substantially instantaneously. In an alternative embodiment of the present invention, by adjusting the effective alkalinity under the conditions described in this disclosure, the onset of lithium precipitation occurs within between a lower limit of approximately one milli-second and an upper limit of approximately one second. In this range approximately means plus or minus twenty (20) percent. In various embodiments of the present invention, lithium can be directly extracted from the source brine as a carbonate. Thus, no subsequent carbonation facility is needed for the system and process. Consequently, the present invention effectively eliminates the need for transporting lithium materials (brines or ores) from a mining site or lithium concentrates (or eluates) from a concentration site, to a mineralization facility, significantly reducing economic and environmental burdens (limited production rates, local freshwater consumption, fuel consumption, CO₂ emissions, etc.) in the extraction and production process. It is also envisioned that giga/mega factories for lithium battery manufacturing can be built and operated at the source. Thus, it is useful in the art to provide a low capital and environmentally friendly process of extracting lithium from liquid, as disclosed herein.

### BRIEF DESCRIPTION OF THE DRAWINGS

FIG. 1 is a representative experimental outcome showing lithium yields from synthetic geothermal brines.

FIG. 2 is a process flow diagram for the extraction of lithium from geothermal brines.

### DETAILED DESCRIPTION OF THE INVENTION

The disclosed process will become better understood by reviewing the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

The method includes selecting and adjusting the effective alkalinity determined based on the modified alkalinity in a quantity of brine to a preset value. Alkalinity, in general, is a measurement of dissolved alkaline substances, which can represent the capacity or ability of brine to neutralize acids so that the pH does not abruptly change. The phrase ‘effective alkalinity’ means a set of thermodynamic conditions used to activate existing anions and cations to cause a new state of equilibrium (or metastable equilibrium) in a brine to enable precipitation of the cations without needing to purposefully modify the pH of the brine.

Alkalinity, in general, can be expressed in units of concentration. For this disclosure, concentrations of the following species are considered in the effective alkalinity determination, which can be as an individual, a combination, or a total: carbonate and other carbonic species (e.g., CaCO₃, CaMg(CO₃)₂, CO₃²⁻, HCO₃⁻); silicate and other silicon species (e.g., SiO₂, SiO(OH)₃⁻); borate and other boron species (e.g., B(OH)₄⁻); hydroxide species (e.g., OH⁻); and chlorine species (e.g., HOCl, HCl). In some embodiments, alkalinity is modified, which is a partial total alkalinity defined in this disclosure as the balanced concentrations: [HCO₃⁻]+2[CO₃²⁻]+[CaCO₃]+[CaMg(CO₃)₂]+[B(OH)₄⁻]+[OH⁻]+[SiO(OH)₃⁻]+[NH₃]−[H⁺]−[HF]−[HOCl]−[HCl].

The effective alkalinity (A_{eff}) in this disclosure is a unitless parameter and defined as: {(the alkalinity of a brine)+(protonation donors)}/{(the sum of concentrations of anions with charges of 2- or higher)+(the sum of concentrations of dissolved species in the brine)}. ‘Anions with charges of 2- or higher’ means anions with charges of 2-, 3-, 4-, and so on.

In some embodiments, the effective alkalinity can be simplified as the ratio of the alkalinity to the concentration of dissolved species.

In an embodiment of the present invention, the preset effective alkalinity is in a range between a lower limit of approximately 0.0001 and an upper limit of approximately 260. In another embodiment of the present invention, the preset effective alkalinity is in a range between a lower limit of approximately 0.8 and an upper limit of approximately 160. In another embodiment of the present invention, the preset effective alkalinity is in a range between a lower limit of approximately 1 and an upper limit of approximately 110. In this range approximately means plus or minus twenty (20) per cent.

The effective alkalinity expressed this way can effectively enable the determination of desired carbonation for lithium. A non-limiting example includes:

$${A}_{eff} = \{ ( [ {HCO}_{3}^{-} ] + 2 [ {CO}_{3}^{2 -} ] + CaC {O}_{3} ] + {CaMg ( {CO}_{3} )}_{2} ] + [ {B ( OH )}_{4}^{-} ] + [ {OH}^{-} ] + [ {SiO ( OH )}_{3}^{-} ] + [ {NH}_{3} ] - [ {H}^{+} ] - [ HF ] - [ HOCl ] - [ HCl ] ) + ( [ {H}^{+} ] ) \} / \{ ( 2 [ {CO}_{3}^{2 -} ] ) + [ ( {CaCO}_{3} + {CaMg ( {CO}_{3} )}_{2} + {SiO}_{2} + {CO}_{x} + {C}_{x} {H}_{y} ) ] \} . \qquad Eq . 1$$

Note the total alkalinity component in this equation, if charges and protons are balanced, should not be affected by the pH, temperature, and pressure. Theoretical, estimated, or predicted concentrations can be used for some species if not available or as desired. The effective alkalinity can be time dependent and a determined, estimated, or measured value at a particular time can be used against a preset value. Exemplified calculations of the A_{eff} using Eq. 1 are given in Table 1 where concentrations of constituents of each brine sample are given in mg/L. For example, for Brine 1, the A_{eff} is 1.053.

TABLE 1
Exemplified calculations of effective alkalinity
(A_{eff}) using Eq. 1 where concentrations of constituents
in each brine sample are given in mg/L.

| | Brine 1 | Brine 2 | Brine 3 | Brine 4 |
|---|---|---|---|---|
| A_{eff} | 1.053 | 2.015 | 6.272 | 0.121 |
| [HCO₃⁻] + 2[CO₃²⁻] | 2.60E+02 | 7.18E+02 | 4.36E+04 | 4.50E+02 |
| [CaCO₃] | 1.81E+02 | 5.88E+02 | 2.00E+02 | 3.69E+02 |
| [CaMg(CO₃)₂] | 3.62E+00 | 1.18E+01 | 4.00E+00 | 7.38E+00 |
| [B(OH)₄⁻] | 2.00E−03 | 2.00E−03 | 2.00E−03 | 2.00E−03 |
| [OH⁻] | 2.69E−01 | 2.69E−03 | 2.69E−01 | 3.39E−06 |
| [H⁺] | 6.31E−07 | 6.31E−05 | 6.31E−07 | 5.01E−02 |
| [SiO(OH)₃⁻] | 0.00E+00 | 0.00E+00 | 0.00E+00 | 0.00E+00 |
| [NH₃] | 6.16E+01 | 2.00E+02 | 6.80E+01 | 1.25E+02 |
| [HF] | 1.00E−01 | 5.00E−01 | 7.00E−01 | 1.00E+00 |
| [HOCl] | 1.00E−03 | 5.00E−03 | 1.00E−03 | 5.00E−03 |
| [HCl] | 1.00E−04 | 5.00E−04 | 1.00E−04 | 5.00E−04 |
| SiO₂ | 2.57E+02 | 1.30E+02 | 1.95E+02 | 7.50E+01 |
| COₓ | 1.45E−01 | 1.21E+01 | 1.45E−01 | 7.40E+03 |
| CₓH_{y} | 5.00E−02 | 1.00E+01 | 8.00E−02 | 5.00E−02 |

When the effective alkalinity is optimally adjusted, the following exemplified elemental reaction for lithium carbonation is expected:

$$2 {Li}^{+} + {C}^{4 +} + 3 {O}^{2 -} = {Li}_{2} {CO}_{3} \qquad Eq . 2$$

Unlimited resource examples for Li⁺ can include Li ions, LiCl, LiOH, LiOH·H₂O, Li₂CO₃, Li₂O, and lithium-bearing minerals. Unlimited resource examples for C⁴⁺ can include carbonic species, carbonates, air, and trapped air. Unlimited resource examples for O²⁻ can include carbonic species, carbonates, oxygen-bearing ions, oxygen-bearing compounds, dissolved oxygen, air, and trapped air.

In an embodiment of the present invention, the effective alkalinity adjustment is performed by controlling concentrations of species mentioned in Eq. 1, and Eq. 2 by any known physical means. In an alternative embodiment of the present invention, the effective alkalinity adjustment is performed by controlling concentrations of species mentioned in Eq. 1, and Eq. 2 by chemical reactions that induce by, for example, carbonation and decarbonization where carbonic species is added and removed, respectively.

In an embodiment of the present invention, the carbonic species can originate from interactions with carbonic solids, gases, and liquids. In another embodiment of the present invention, the carbonic species can originate from interactions with solids, gases, and liquids containing carbonic species such as alkali carbonates, ultrafine gaseous carbonic spheroids having a diameter of ≤999 nanometers, dissolved carbonic gases, and respective ions. In an alternative embodiment of the present invention, the carbonic species can originate from, produced by, or controlled by interactions with carbonic solids, gases, and liquids, or those containing carbonic species such as alkali carbonates, ultrafine gaseous carbonic spheroids having a diameter of ≤999 nanometers, dissolved carbonic gases, and respective ions. In an embodiment of the present invention, the carbonic species can be removed by a physical separation(s), such as flotation, filters, and membranes. In an alternative embodiment of the present invention, the carbonic species can be removed by a chemical reaction(s). In another embodiment of the present invention, the carbonic species can be removed by a combination of a physical means and a chemical reaction. In an embodiment of the present invention, the carbonic species is generated in situ. In an embodiment of the present invention, the carbonic species is generated in situ using direct air capture.

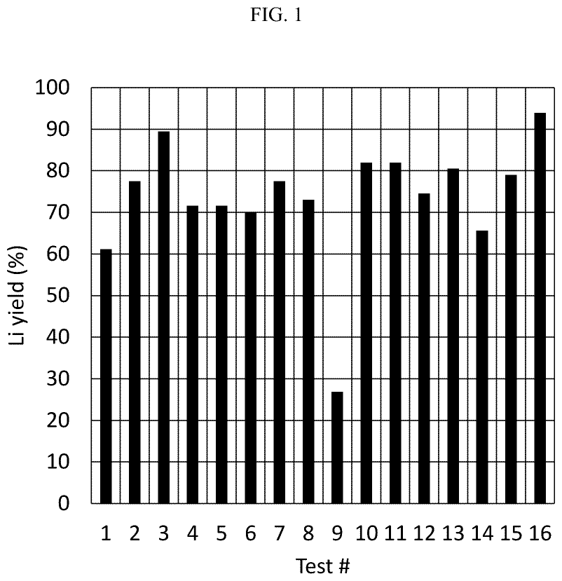

To demonstrate the invention, synthetic brines of lithium concentration in the range of 0.016 wt. %-0.025 wt. % (160-250 ppm Li) with 2% salinity (20,000 ppm NaCl), containing other dissolved solids of K, Ca, Si, Cl, and Mg, were prepared and tested. The lithium was introduced as LiCl to simulate natural brine materials. At each test, the effective alkalinity was adjusted to approximately 0.01. Temperature of the brines was adjusted to 43° C. (or lower) by exchanging heat with a metal plate. Approximately 10 minutes after the effective alkalinity adjustment, the brine sample was drained through a sieve and particles formed in the brine larger than 45 mm were collected and subjected to scanning electron microscopy, energy dispersive X-ray spectroscopy, and laser induced breakdown spectroscopy. The particles collected were analyzed and found to be predominantly lithium carbonate. No impurity from the dissolved solids (K, Ca, Si, Cl, and Mg) was detected to a ppm level. The presence of sodium precipitates was also noted among the collected particles. The overall Na/Li ratio collectively was drastically reduced to approximately 0.19. Resulting yields of lithium are presented as a percent lithium recovery in FIG. 1. Up to 94% lithium was extracted and recovered as lithium carbonate as a matter of 10 minutes directly in the synthetic brines without employing post-mineralization steps.

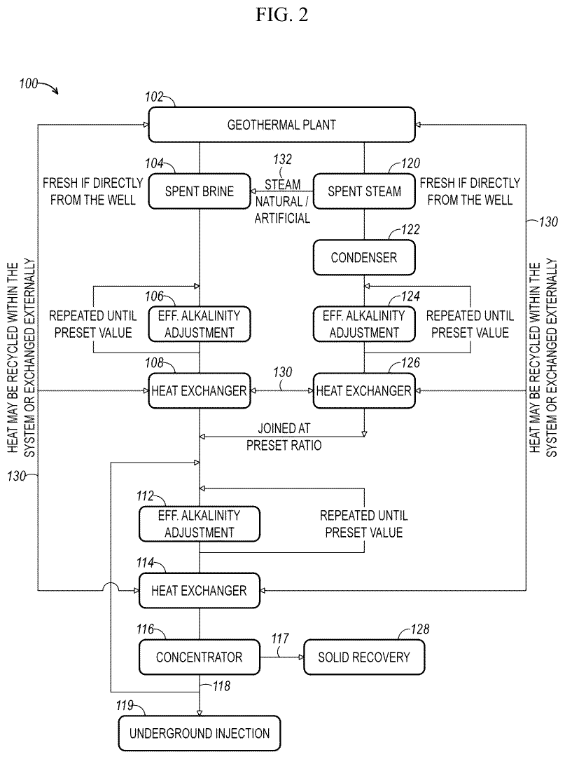

The process described as applied to geothermal brines is illustrated in FIG. 2. First, a brine (104) and steam (120) are provided from a geothermal plant (102). They can be fresh materials directly from the well or combined. In one embodiment, a geothermal brine is provided in a temperature range of 30-350° C. along with steam. In another embodiment, a geothermal brine is provided in a temperature range of 60-220° C. along with steam. In another embodiment, a geothermal brine is provided in a temperature range of 270-350° C. along with steam. A spent brine can be in a range of 25-80° C. and spent steam in a temperature range of 80-380° C. Steam in this disclosure means the gaseous state of water, which can include water droplets and water vapor below its boiling point. Optionally, additional steam (132) can be provided from the brine (104) in the main stream (104, 106, 108, 112, 114, 116, 119) to the steam (120) from the geothermal plant (102), which can be prepared naturally (i.e., as present) or artificially by any known means, such as boilers (not shown). Hydraulic pressure of the brine (104) from underground (not shown) or thermal sources (not shown) can be utilized to move the liquid medium in the main stream through the process. Alternatively, the hydraulic pressure is converted to energy to be utilized in the process or stored for later use. Second, the brine's effective alkalinity is adjusted toward a preset value at an effective alkalinity adjustment step (106), which can be repeated as desired or until a preset value is obtained.

In an embodiment of the present invention, a preset value for the effective alkalinity is determined in such a way that a total mass of available carbonic species (ionic, aqueous, and dissolved) in brine is equal to or higher than that determined by the stoichiometry of the final product or byproduct. In an alternative embodiment of the present invention, an alkalinity in the range of 2-200 mg/L CaCO₃ is preferred. In another embodiment of the present invention, an alkalinity in the range of 100-500 mg/L CaCO₃ is more preferred. In another alternative embodiment of the present invention, an alkalinity in the range of 0.3-100 g/L CaCO₃ is most preferred.

Third, the brine undergoes a heat exchanger step (108) to adjust the temperature of the brine to a preset value, which can be repeated as desired or until a preset value is obtained, where heat (130) is exchanged within the system (100) such as with the geothermal plant (102) and other heat exchangers, e.g., (114) or externally, for example, with heat exchangers located outside the system (not shown). Heat exchange in this disclosure can be conducted by any known methods including counter flow or parallel flow heat exchangers such as tube and shell, direct liquid flow, direct gas flow, and radiators. In an embodiment of the present invention, a preset temperature of the brine is in a range of approximately 5° C.-approximately 80°° C. In another embodiment of the present invention, a preset temperature of the brine is in a range of approximately 25° C.-approximately 80° C. In another embodiment of the present invention, a preset temperature of the brine is in a range of approximately 15° C.-approximately 50° C. In this range approximately means plus or minus twenty (20) percent. Any heat, if harvested anywhere in the process, can be recycled or reused within the system (100) where needed or stored for future use.

The steam (120) from the geothermal plant (102) undergoes heat extraction at a condenser step (122), where the steam transforms to liquid water (i.e., condensed water), and further at the heat exchanger step (126), where heat (130) is exchanged within the system (100) or externally (not shown) to adjust the temperature of the condensed water from (122) to a preset value at the heat exchanger step (126). The effective alkalinity in the condensed water from (122) is adjusted toward a preset value at an effective alkalinity adjustment step (124), which can be repeated as desired or until a preset value is obtained. In an embodiment of the present invention, the steam utilization steps (120)-(126) are optional.

If the steam utilization steps are conducted, the condensed water from (126) joins the brine from the heat exchanger step (108), and the effective alkalinity in the main stream brine is adjusted toward a preset value tuned for lithium precipitation at an effective alkalinity adjustment step (112), which can be repeated as desired or until a preset value is obtained. The main stream brine from (122) then undergoes a heat exchanger step (114) where heat (130) is exchanged within the system or externally to adjust the temperature of the brine in the main stream to a preset value. The lithium in the brine with the adjusted effective alkalinity reacts with the anions and precipitates as solid Li₂CO₃ (precipitated material). The brine with the precipitates after (114) undergoes a concentrator step (116) to concentrate the precipitated Li₂CO₃ materials. The concentrate (117) from the concentrator step (116) is separated from the main stream (104, 106, 108, 112, 114, 116, 119) and undergoes a solid recovery step (128) where the Li₂CO₃ is recovered. Concentration and separation (or recovery) can be performed by any conventional means, including gravitational, density, centrifuge, flotation, filtration, charge, surface tension, membrane, screening, absorption, adsorption, and electrostatic. The spent brine (118), after the solid concentrator step (116), can be returned to the main stream (104, 106, 108, 112, 114, 116, 119) before the effective alkalinity adjustment step (112) to recycle. The spent brine (118) after lithium removal, i.e., after the concentrator step (116) can be injected back underground at an underground injection step (119) or transported to a reservoir or other storage units. The overall process described above can be either batch or continuous and can be operated within an underground well.

In one embodiment, a preset value of the effective alkalinity at each effective alkalinity adjustment step and a preset value of the brine temperature and each heat exchanger step are readjusted at each repetition to maximize the outcome. The number of repetitions and increment, interval, and duration at each repetition may be selected as desired.

### Definitions

The following definitions apply herein unless otherwise indicated.

For the purposes of this disclosure, carbonic species or reactant carbonic species includes: aqueous species with non-limiting examples including carbonic acid, bicarbonate, and carbonate; gaseous species such as carbon monoxide, carbon dioxide, and hydrocarbons; dissolved gaseous species; anionic forms of gaseous species; cationic forms of gaseous species; and protonated and deprotonated forms of gaseous species.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and sub-combinations of the various elements, features, functions, and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and sub-combinations of the disclosed inventions that are believed to be novel and non-obvious. Inventions embodied in other combinations and sub-combinations of features, functions, elements, and/or properties may be claimed through amendment of those claims or presentation of new claims in the present application or in a related application. Such amended or new claims, whether they are directed to the same invention or a different invention and whether they are different, broader, narrower, or equal in scope to the original claims, are to be considered within the subject matter of the inventions described herein.

1. A method for extracting lithium from geothermal brines comprising:
providing a geothermal brine in a main process stream;
adjusting an effective alkalinity in the geothermal brine to a preset value using at least one effective alkalinity adjustment step;
exchanging heat with the geothermal brine to adjust a brine temperature to a preset value using at least one heat exchanger step; and
consequentially generating precipitated lithium.

2. The method of claim 1, where the method further comprises:
concentrating the precipitated lithium using at least one concentration step;
separating the precipitated material using at least one separation step; and
exiting a spent geothermal brine.

3. The method of claim 1, where the geothermal brine has a temperature between:
a lower limit of approximately 30° C.; and
an upper limit of approximately 350° C.

4. The method of claim 1, where the geothermal brine has a temperature between:
a lower limit of approximately 60° C.; and
an upper limit of approximately 220° C.

5. The method of claim 1, where the geothermal brine has a temperature between:
a lower limit of approximately 270° C.; and
an upper limit of approximately 350° C.

6. The method of claim 1, where a heat exchanger adjusts a temperature of the geothermal brine to a preset value between:
a lower limit of approximately 5° C.; and
an upper limit of approximately 80° C.

7. The method of claim 1, where a heat exchanger adjusts the temperature of the geothermal brine to a preset value between:
a lower limit of approximately 25° C.; and
an upper limit of approximately 80° C.

8. The method of claim 1, where a heat exchanger adjusts the temperature of the geothermal brine to a preset value between:
a lower limit of approximately 15° C.; and
an upper limit of approximately 50° C.

9. The method of claim 1, where the method further comprises:
providing steam in a side process;
condensing the steam to generate condensed water;
adjusting the effective alkalinity of the condensed water to a second preset value using at least one effective alkalinity adjustment step;
exchanging heat with the condensed water using at least one heat exchanger step; and
returning the condensed water to the geothermal brine to the main process stream.

10. The method of claim 9, where excess steam from the geothermal brine joins with the spent steam.

11. The method of claim 9, where additional steam is generated using the geothermal brine, which joins the spent steam.

12. The method of claim 1, where the effective alkalinity is a ratio of the alkalinity to the concentration of dissolved species.

13. The method of claim 1, where the effective alkalinity is between:
a lower limit of approximately 0.0001; and
an upper limit of approximately 260.

14. The method of claim 1, where the effective alkalinity is between:
a lower limit of approximately 0.8; and
an upper limit of approximately 160.

15. The method of claim 1, where the effective alkalinity is between:
a lower limit of approximately 1; and
an upper limit of approximately 110.

16. The method of claim 1, where the precipitated material recovered is a carbonate, carbide, or a carbon-bearing compound, consisting of lithium.

17. The method of claim 1, where a preset value of the effective alkalinity at the effective alkalinity adjustment step and a preset value of the brine temperature and the heat exchanger step are readjusted at each repetition.

18. A method for extracting lithium from geothermal brines comprising:
(a) providing a geothermal brine having a temperature range between:
a lower limit of approximately 30° C.; and
an upper limit of approximately 350° C.;
(b) adjusting an effective alkalinity in the geothermal brine to a preset value between:
a lower limit of approximately 0.01; and
an upper limit of approximately 30, using at least one effective alkalinity adjustment step;
(c) exchanging heat with the geothermal brine using at least one heat exchanger step where the heat exchanger adjusts the temperature of the geothermal brine to between:
a lower limit of approximately 5° C.; and
an upper limit of approximately 80° C.; and
(d) consequentially generating precipitated lithium.

19. The method of claim 18, where the method further comprises:
concentrating the precipitated lithium using at least one material concentration step; and
separating the precipitated material using at least one material separation step.
